(19) United States
(12) Patent Application Publication
(10) Pub. No.: US 2014/0320068 A1
(43) Pub. Date: Oct. 30, 2014

(54) BATTERY CHARGER, BATTERY CHARGING METHOD AND ELECTRONIC APPARTUS

(71) Applicant: Kabushiki Kaisha Toshiba, Tokyo (JP)

(72) Inventor: Shigeyasu Iwata, Hamura-shi (JP)

(73) Assignee: KABUSHIKI KAISHA TOSHIBA, Tokyo (JP)

(21) Appl. No.: 14/063,980

(22) Filed: Oct. 25, 2013

(30) Foreign Application Priority Data
Apr. 26, 2013 (JP) 2013-093668

(51) Int. Cl. H02J 7/00

(52) U.S. Cl. CPC H02J 7/0052
USPC 320/107

(57) ABSTRACT

According to one embodiment, a first switch outputs charging voltage and charging current for battery charge. A second switch is smaller than the first switch, and outputs voltage and current generated based on the control voltage from the regulator. A voltage detector detects output voltage of the first switch if the output voltage is or more than a predetermined value. A current detector detects output current of the second switch if the output current is or less than a predetermined value. A logic circuit determines whether charging is continued or stopped based on a logical operation performed on outputs from the voltage detector and the current detector.

### CROSS-REFERENCE TO RELATED APPLICATIONS

This application is based upon and claims the benefit of priority from Japanese Patent Application No. 2013-093668, filed Apr. 26, 2013, the entire contents of which are incorporated herein by reference.

### FIELD

Embodiments described herein relate generally to battery charger, battery charging method, and electronic apparatus.

### BACKGROUND

The conventional charging apparatus is carrying out series connection of the sensing resistance to the output side of the regulator which outputs charging current and charge voltage. The distinction circuit which distinguishes a charge end detects the charging current of sensing resistance, and is distinguishing the charge end. However, since sensing resistance is accompanied by power loss, the value of this sensing resistance is determined by the trade-off of the power loss consumed by resistance, and current measurement accuracy.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates a structural example of a battery charger of a present embodiment.

FIG. 2 illustrates a waveform chart of voltage, current, and logic determining output indicative of a working example of an electronic apparatus of FIG. 1.

FIG. 3 illustrates detailed circuits inside the blocks of the apparatus of FIG. 1.

FIG. 4 illustrates an example of use of the battery charger.

FIG. 5 illustrates another example of use of the battery charger.

FIG. 6 illustrates a still another example of the use of the battery charger.

FIG. 7 illustrates a still another example of the use of the battery charger.

### DETAILED DESCRIPTION

Various embodiments will be described hereinafter with reference to the accompanying drawings.

In general, according to one embodiment, there are provided battery charger, battery charging method, and electronic apparatus which offer reduction of power loss and good accuracy in current measurement.

According to an embodiment of the present disclosure, the battery charger comprises:

a first switch to which power supply voltage is applied, the first switch configured to output charging voltage and charging current;

a regulator comprising an operational amplifier configured to control the first switch by control voltage based on a difference between voltage generated from the charging voltage and reference voltage;

a second switch to which the power supply voltage is applied, the second switch being smaller than the first switch and configured to output voltage and current based on the control voltage from the operational amplifier;

a voltage detector configured to detect output voltage of the first switch if the output voltage is or more than a predetermined value;

a current detector configured to detect output current of the second switch if the output current is or less than a predetermined value; and

a logic gate configured to obtain a control signal to determine whether charging is continued or stopped based on a logical operation of outputs from the voltage detector and current detector.

An embodiment will further be described with reference to the drawings.

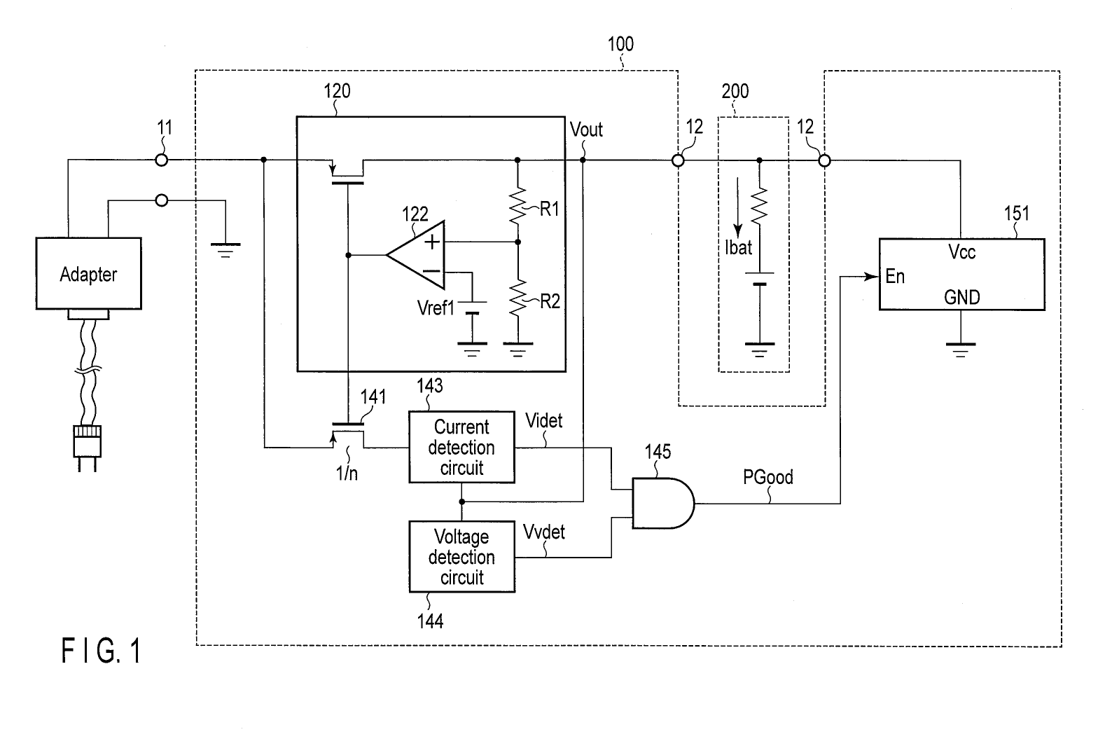

FIG. 1 illustrates a basic structural example of a battery charger 100 of the present embodiment.

An input terminal 11 is connected to a commercial power socket via an adapter including a rectifier. For example, a commercial power supply is rectified into power supply voltage for battery charge and applied to the input terminal 11.

The input terminal 11 is connected to a source terminal of a switching element 121 formed of a power semiconductor device in a regulator 120. A drain terminal of switching element 121 is connected to an output terminal 12 configured to output both output voltage Vout (charging voltage) and current Ibat (charging current) for battery charge.

The output terminal 12 may be connected to the positive terminal of a rechargeable battery 200. Furthermore, a power terminal of a load 151 is connected to the output terminal 12. Here, the load 151 is, for example, a controller of a central processing unit (CPU). The rechargeable battery may be referred to as a battery.

The regulator 120 is now described. The output terminal 12 is connected to a ground terminal via a series circuit of resistors R1 and R2. Resistors R1 and R2 comprise connecting points connected to the positive input terminal of an operational amplifier 122, and reference voltage Vref1 is applied to the negative input terminal of the operational amplifier 122.

The operational amplifier 122 comprises an output terminal which is connected to a gate (control terminal) of the switching element 121 formed of a semiconductor. Furthermore, the output terminal of the operational amplifier 122 is connected to a control terminal of a switching element 141 which is formed of a semiconductor. Thus, output voltage and/or output current from switching elements 121 and 141 are controlled corresponding to the output of the operational amplifier 122.

Here, switching element 141 has a size (area, for example) which is smaller than that of switching element 121. For example, switching elements 121 and 141 have the same height (depth), the size of switching element 141 is 1/n (n is an integer) of the area of switching element 121. In that case, when switching elements 121 and 141 are compared to each other in an enlarged image via an inspection device, the area of switching element 121 is larger than that of switching element 141. In other words, the area of switching element 141 is physically smaller than that of switching element 121. From this structure, it is acknowledged that the current passing through switching element 141 is, approximately in proportion to the area, smaller as compared to the current passing through switching element 121. Thus, power consumption for current detection can be reduced.

Switching element 141 comprises a source connected to the input terminal 11 and a drain connected to a current detection circuit 143. When the current passing through switching element 121 is (i), the current passing through switching element 141 is, ideally, given by (i×(1/n)) which is smaller than (i) and follows the current (i). The value n is set to be sufficiently small in comparison with the self-consumption current of the regulator 120.

A current detection circuit 142 converts current passing through the drain of switching element 141 to voltage, and when the converted voltage exceeds a predetermined voltage Vref2, the current detection circuit 142 outputs detection output Videt to be input to one of the input terminals of a logic gate 145.

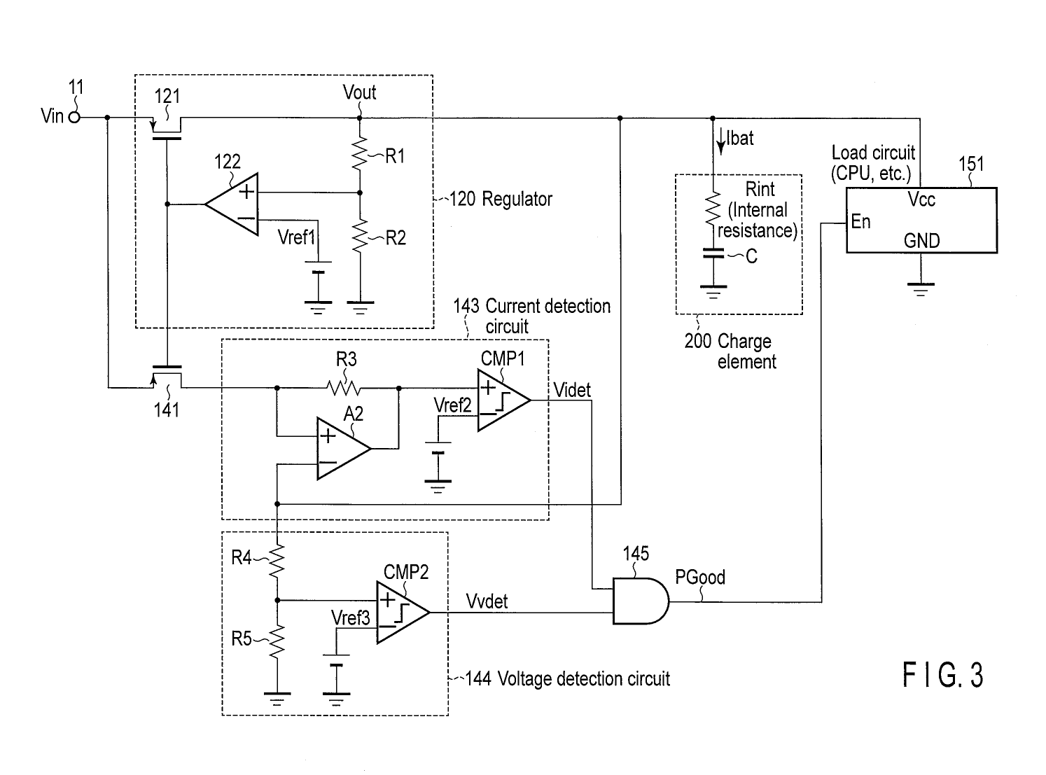

When the drain current of switching element 141 is converted into voltage, the current detection circuit 142 utilizes a trans-impedance amplifier using the resistances and operational amplifier (detailed explanation is given below with reference to FIG. 3). Here, bias voltage used therein follows the output voltage Vout of the regulator 120.

Thus, switching elements 121 and 141 work in the same condition, and the drain current of switching element 141 follows the drain current of switching element 121 with high accuracy.

A voltage detection circuit 144 compares divided voltage of the output voltage Vout of the regulator 120 and reference voltage Vref3. When detecting that the output voltage Vout (battery voltage) exceeds a predetermined value, the voltage detection circuit 144 outputs detection output Vvdet and inputs detection output Vvdet to the logic gate 145.

The logic gate 145 outputs charge completion detection output PGood when, for example, both the detection output Videt and detection output Vvdet are high, and inputs the charge completion detection output PGood to a load circuit 151. Although this is not illustrated, when the charge completion detection output PGood is input and the charge is completed at that time, switching elements 121 and 141 are turned off based on a control signal from the load circuit (including CPU) 151. On the other hand, when the charge is started, switching elements 121 and 141 are turned on based on the control signal from the load circuit (including CPU) 151. Furthermore, the control signal may be used to change color emitted by an indicator (LED, for example) so that a user can recognize charge/discharge conditions such as “charge in progress” or “charge completion”, or the like.

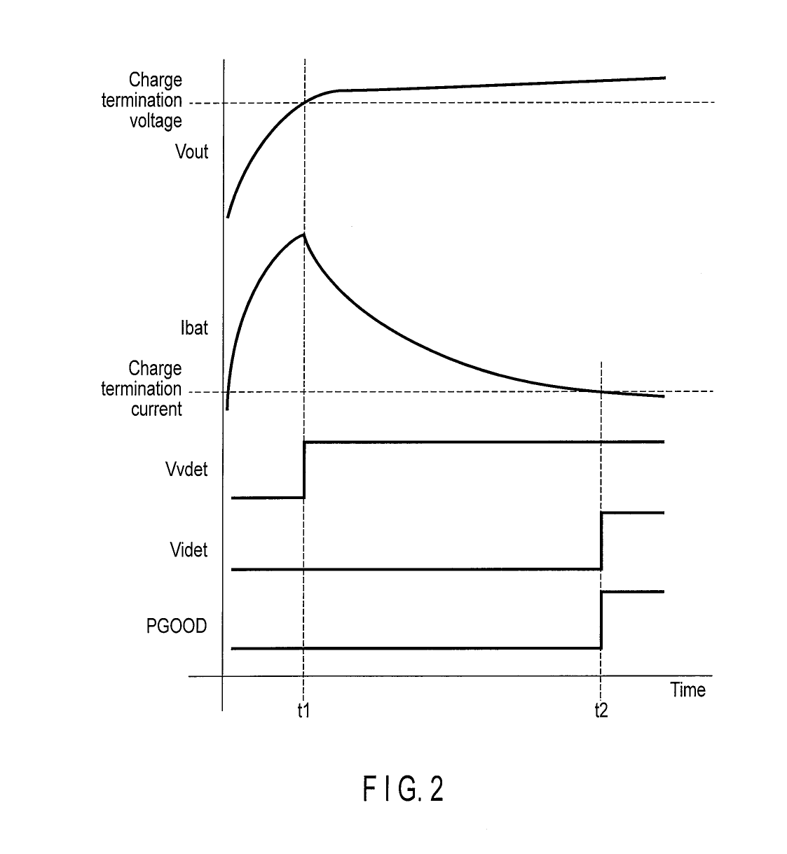

FIG. 2 illustrates waveforms of voltage, current and logic determining output indicative of a working example of the above-mentioned apparatus. The output voltage Vout of the regulator 120 rises steeply when charging starts, and exceeds the predetermined voltage Vref3 (at time t1, for example). At that time, the voltage detection circuit 144 outputs the detection output Vvedt (high level). Furthermore, the current Ibat passing through the rechargeable battery 200 rises steeply and falls gradually. After a lapse of a certain period of time, the current Ibat lowers under a current value which is a target value for termination of time point charging, for example. At that time, the current detection circuit 143 outputs the detection output Videt (high level).

When the detection output Vvdet and detection output Videt are obtained, the logic gate 145 outputs a logic signal PGGood indicative of the charge completion.

FIG. 3 illustrates a circuit diagram of a structural example inside the blocks of the apparatus in detail. The current detection circuit 143 comprises an operational amplifier A2 and a trans-impedance amplifier formed of a resistor R3 connected between the output terminal and negative terminal of the operational amplifier A2. The trans-impedance amplifier converts current passing through the drain of switching element 141 to voltage.

Between ground and the positive terminal of the operational amplifier A2, a series circuit of resistances R4 and R5 is connected together with the output terminal of the regulator 120. The voltage output terminal of the operational amplifier A2 is connected to the negative terminal of a comparator CMP1. To the positive terminal of comparator CMP1, reference voltage Vref2 is applied. The aforementioned detection output Videt is obtained in the output terminal of comparator CMP1.

The connecting points of resistors R4 and R5 are connected to the positive terminal of a comparator CMP2, and the reference voltage Vref3 is applied to the negative terminal of comparator CMP2. The aforementioned Vvedet is obtained in the output terminal of comparator CMP2.

The rechargeable battery (or storage element) 200 has an internal resistance Rint and capacitance C, and thus, as illustrated in FIG. 2, the charge current Ibat flows in a large value when the voltage is applied but flows in smaller value with the progression of charge.

Here, the following equation is applicable.

Vout=Rint×Ibat+Cv

Vout is regulator output voltage, Rint is a rechargeable battery internal resistance, Cv is battery voltage, and Ibat is battery current.

The above-described battery charger does not use a conventionally-used sense resistance for current detection but uses a second switching element feeding minute current. As a result, the charging current can be detected with lesser loss of power and higher accuracy as compared to a conventionally-used battery charger. Here, since elements such as operational amplifier and comparator are used in the conventionally-used battery charger as well, the loss of power due to these elements is acknowledged the same in both chargers. However, taking the sense resistance which consumes a relatively large amount of power into consideration, the technique of the present embodiment can offer great reduction in power consumption as compared to a conventional battery charging technique.

The battery charger 100 may be structured as an independent material, or may be incorporated into an electronic apparatus (such as digital camera, portable computer, personal computer, tablet computer, cellphone, television receiver using rechargeable battery, and recording/reproducing apparatus, etc.).

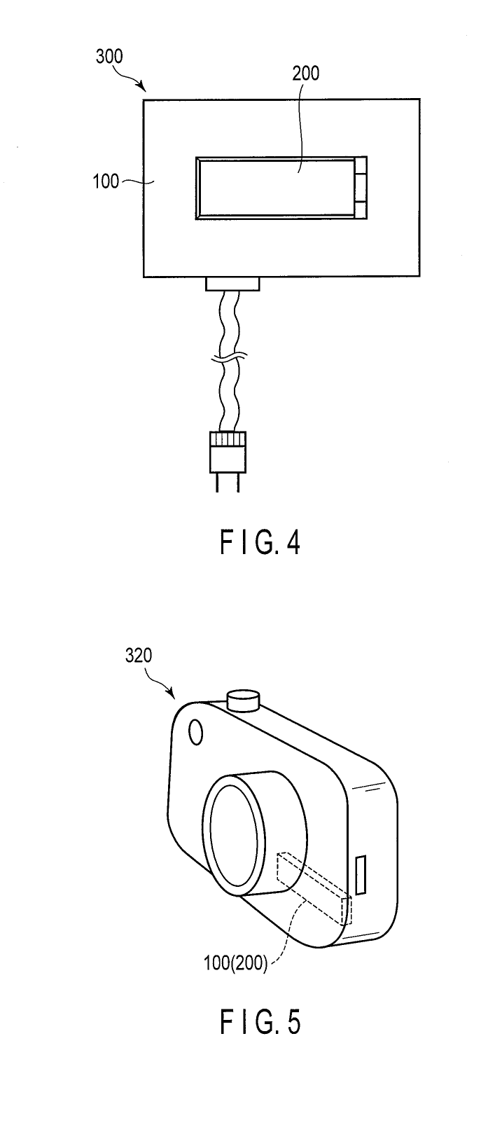

FIG. 4 illustrates a recharger 300 including the battery charger 100 illustrated in FIG. 1. The rechargeable battery 200 to be charged is attachable/detachable to/from the recharger 300. The recharger 300 comprises a plug to be inserted into a commercial power socket for battery charge. When the battery charge is completed, the rechargeable battery 200 is mounted on a battery receiver of an electronic apparatus (for example, a digital camera, personal computer, television receiver, and the like) which is used separately.

In the example of FIG. 4, the battery charger 100 is structured independently; however, the battery charger 100 may be incorporated inside the electronic apparatus as shown in FIGS. 5, 6 and 7.

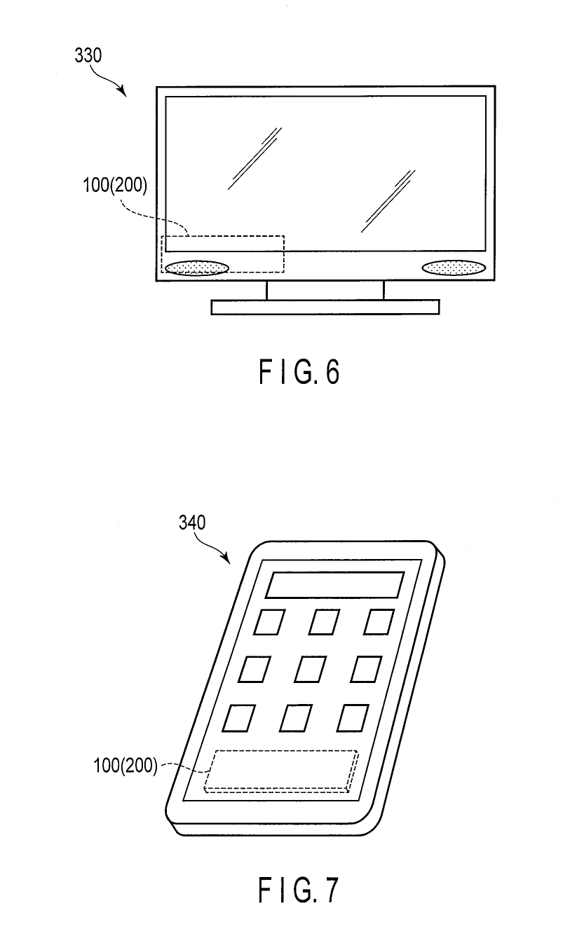

FIG. 5 illustrates a digital camera 320 equipped with a built-in battery charger 100 as shown in FIG. 1. FIG. 6 illustrates a television receiver 330 which is operable by power from either commercial power or rechargeable battery (battery). FIG. 7 illustrates a mobile device 340 such as a tablet computer or cellphone.

In the above-mentioned descriptions, terms such as “circuit” and “unit” may be replaced with “apparatus”, “device”, “block”, and “module”. The switching element may be replaced with the switch. The voltage detection circuit and the current detection circuit may be replaced with the voltage detector and the current detector, respectively. The scope of the invention is not changed by such a terminological replacement. Furthermore, in claims, a structural element recited may be further divided, structural elements may be combined together, and the divided elements and combined element may be used together. The scope of the invention is not changed by such a terminological modification. The apparatus of the present embodiment is applicable to the method claims.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery charger comprising:
a regulator having a first switch to which power supply voltage is applied, and an operational amplifier,
the first switch configured to output charging voltage and charging current, the operational amplifier configured to control the first switch by control voltage based on a difference between voltage generated from the charging voltage and reference voltage;
a second switch to which the power supply voltage is applied, the second switch being smaller than the first switch and configured to output voltage and current based on the control voltage from the operational amplifier;
a voltage detector configured to detect output voltage of the first switch if the output voltage is or more than a predetermined value;
a current detector configured to detect output current of the second switch if the output current is or less than a predetermined value; and
a logic circuit configured to obtain a control signal to determine whether charging is continued or stopped based on a logical operation of outputs from the voltage detector and current detector.

2. The battery charger of claim 1, wherein a second current running through the second switch is smaller than a first current running through the first switch.

3. The battery charger of claim 1, wherein, if the first and second switches have the same height, the first switch has an area n-times larger than the area of the second switch (n is an integer), and the first current running through the first switch is n-times larger than the second current running through the second switch.

4. The battery charger of claim 1, wherein the current detector comprises a trans-impedance amplifier configured to perform voltage conversion of the output current of the second switch, and bias voltage of the trans-impedance amplifier is generated based on the output voltage of the regulator.

5. The battery charger of claim 4, wherein the current detector further comprises a comparator configured to compare the output voltage of the trans-impedance amplifier to reference voltage and to detect the output current only when the output current is or less than a predetermined value.

6. The battery charger of claim 4, wherein the trans-impedance amplifier is generated based on the output voltage of the first switch and follows thereto.

7. The battery charger of claim 1, wherein the voltage detector comprises divided voltage which is divided output voltage of the first switch and a comparator configured to compare the reference voltage.

8. A battery charging method for a battery charger comprising a regulator having first switch to which power supply voltage is applied, and an operation amplifier, the first switch element configured to output charging voltage and charging current, and the operational amplifier configured to control the first switch by control voltage based on a difference between voltage generated from the charging voltage and reference voltage, and a voltage detector configured to detect output voltage of the first switch if the output voltage is or more than a predetermined value, the method comprising:
using a second switch to which the power supply voltage is applied, the second switch being smaller than the first switch and configured to output voltage and current based on the control voltage from the operational amplifier;
detecting output current of the second switch if the output current is or less than a predetermined value; and
determining whether charging is continued or stopped based on a logical operation of outputs from the voltage detector and current detector.

9. The battery charging method for the battery charger of claim 8, wherein output voltage of a trans-impedance amplifier is compared to reference voltage and output current which is or less than a predetermined value is detected.

10. An electronic apparatus equipped with an internal charging circuit configured to charge a battery, the charging circuit comprising:
a regulator having a first switch to which power supply voltage is applied, and an operational amplifier,
the first switch configured to output charging voltage and charging current, the operational amplifier configured to control the first switch by control voltage based on a difference between voltage generated from the charging voltage and reference voltage;
a second switch to which the power supply voltage is applied, the second switch being smaller than the first switch and configured to output voltage and current based on the control voltage from the operational amplifier;
a voltage detector configured to detect output voltage of the first switch if the output voltage is or more than a predetermined value;
a current detector configured to detect output current of the second switch if the output current is or less than a predetermined value; and
a logic circuit configured to obtain a control signal to determine whether charging is continued or stopped based on a logical operation of outputs from the voltage detector and current detector.
